(19) United States
(12) Patent Application Publication
(10) Pub. No.: US 2014/0201545 A1
(43) Pub. Date: Jul. 17, 2014

(54) EXTERNAL STORAGE DEVICE AND METHOD FOR STARTING UP EXTERNAL STORAGE DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: ZHOU-PENG TIAN, Shenzhen (CN); YONG-FEI LIANG, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/048,243

(22) Filed: Oct. 8, 2013

(30) Foreign Application Priority Data
Jan. 17, 2013 (CN) 2013100165885

(51) Int. Cl. G06F 1/26

(52) U.S. Cl. CPC G06F 1/266
USPC 713/310

(57) ABSTRACT

An external storage device includes a storage unit, a D flip-flop, a power supply, an interface unit, and a processing unit. The interface unit receives an out-of-band (OOB) signal from a host computer and transmits the OOB signal to a clock input terminal of the D flip-flop. The processing unit transmits a reset signal to a data input terminal of the D flip-flop. When the processing unit detects that an output value on a output terminal of the D flip-flop changes, the processing unit controls the power supply to provide power to the storage unit. A method for starting up an external storage device is also provided.

### REFERENCE TO RELATED APPLICATIONS

This application claims all benefits accruing under 35 U.S.C. §119 from China Patent Application No. 201310016588.5, filed on Jan. 17, 2013 in the State Intellectual Property Office of China. The contents of the China Application are hereby incorporated by reference.

### BACKGROUND

1. Technical Field

The disclosure generally relates to data storage devices, and particularly relates to external storage devices and methods for starting up external storage devices.

2. Description of Related Art

With recent technological advancements such as miniaturization and improved mass productivity of memory devices, external storage devices for computers, have become more available. With an external storage device, a user can easily transport data, such as files, between plural computers by moving data, such as files, into the external storage device from one computer having a data input/output interface, and then by retrieving the data on another computer. The user needs first to connect the external storage device to the computer, then manually presses a power button of the external storage device to start up the external storage device, and then uses the external storage device. It is inconvenient for the user to perform the above steps to use the external storage devices every time.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of an external storage device.

FIG. 2 is a flowchart of one embodiment of a method for starting up an external storage device.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

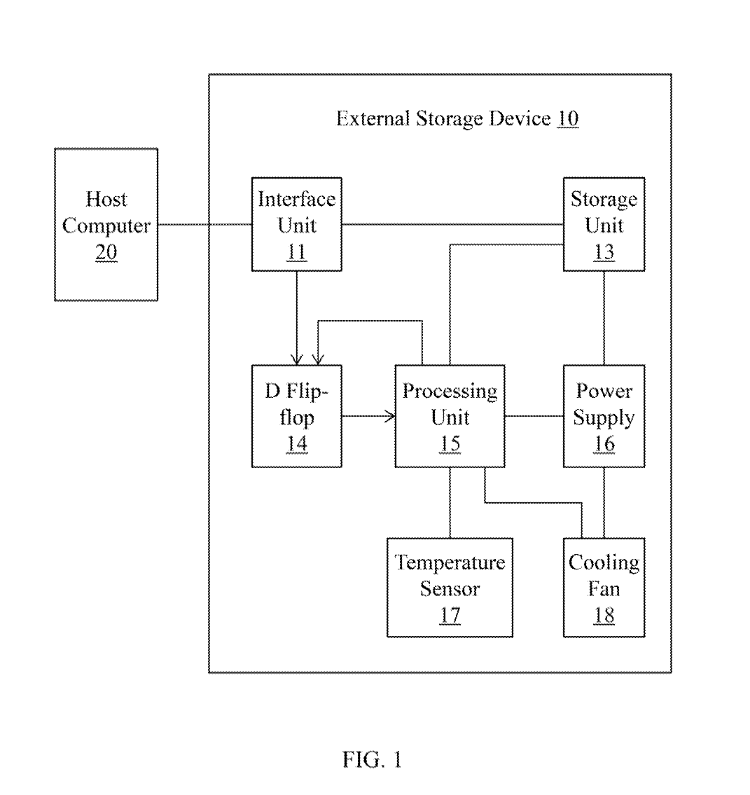

FIG. 1 shows one embodiment of an external storage device 10. The external storage device 10 includes an interface unit 11, a storage unit 13, a D flip-flop 14, a processing unit 15, a power supply 16, a temperature sensor 17, and a cooling fan 18. The external storage device 10 may be connected to a host computer 20.

The interface unit 11 provides an interface, for example a USB terminal, to communicate with the host computer 20. When the external storage unit 10 is connected to the host computer 20, the interface unit 11 may receive an out-of-band (OOB) signal from the host computer 20.

The storage unit 13 provides storage media for storing data. The storage unit 13 may transmit data to the host computer 20 via the interface unit 11 and receive data from the host computer 20 via the interface unit 11.

The D flip-flop 14 includes a clock input terminal, a data input terminal, and an output terminal. The clock input terminal of the D flip-flop 14 is connected to the interface unit 11. The data input terminal of the D flip-flop 14 is connected to an output pin of the processing unit 15. The output terminal of the D flip-flop 14 is connected to the an input pin of the processing unit 15.

The interface unit 11 may transmit the OOB signal to the clock input terminal of the D flip-flop 14. The processing unit 15 may transmit a reset signal to the data input terminal of the D flip-flop 14.

When the clock input terminal of the D flip-flop 14 receives the OOB signal and the data input terminal of the D flip-flop 14 receives the reset signal at the same time, the output value on the output terminal of the D flip-flop 14 changes. Namely, the output voltage of the output terminal turns from a high voltage level to a low voltage level or from a low voltage level to a high voltage level.

When the clock input terminal of the D flip-flop 14 does not receive the OOB signal or the data input terminal of the D flip-flop 14 does not receive the reset signal, the output value on the output terminal of the D flip-flop 14 maintains unchanged. Namely, the output voltage of the output terminal maintains a stable voltage level.

The processing unit 15 detects whether the output value on the output terminal of the D flip-flop 14 changes. When the output value on the output terminal of the D flip-flop 14 changes, the processing unit 15 executes a start-up operation of the external storage device 10. The start-up operation includes controlling the power supply 16 to start providing power to the storage unit 13 and the cooling fan 18, and controlling the cooling fan 18 to start rotating.

The temperature sensor 17 measures an internal temperature of the external storage device 10. The processing unit 15 may adjust a rotation speed of the cooling fan 18 according to the measured internal temperature.

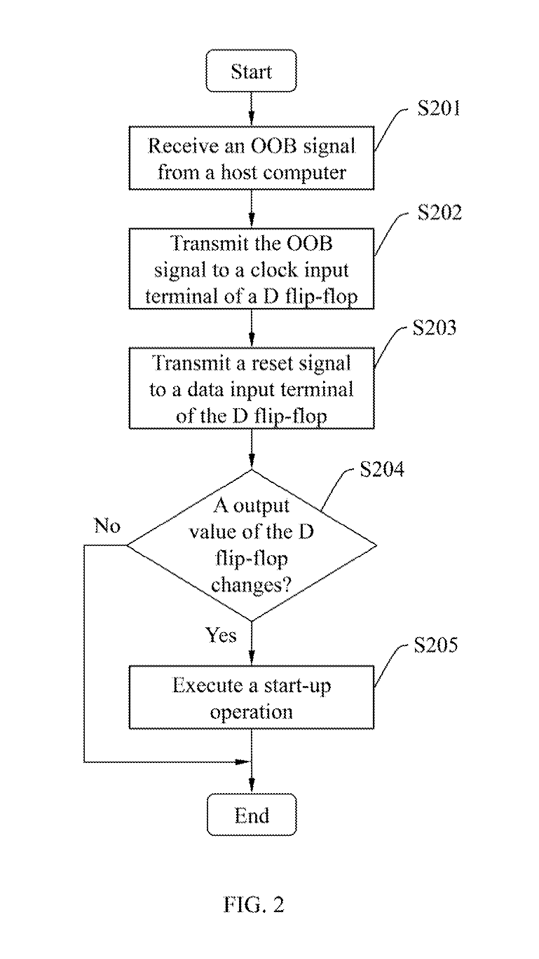

FIG. 2 shows a flowchart of one embodiment of a method for starting up the external storage device 10. The method includes the following steps.

In step S201, the interface unit 11 receives an OOB signal from the host computer 20.

In step S202, the interface unit 11 transmits the OOB signal to the clock input terminal of the D flip-flop 14.

In step S203, the processing unit 15 transmits a reset signal to the data input terminal of the D flip-flop 14.

In step S204, the processing unit 15 detects whether the output value on the output terminal of the D flip-flop 14 changes. When the output value on the output terminal of the D flip-flop 14 changes, the flow proceeds to step S205, otherwise, the flow ends.

In step S205, the processing unit 15 executes a start-up operation of the external storage device 10. The start-up operation includes controlling the power supply 16 to start providing power to the storage unit 13 and the cooling fan 18, and controlling the cooling fan 18 to start rotating.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. An external storage device, comprising:
a storage unit configured for storing data;
a power supply;
a D flip-flop comprising a clock input terminal, a data input terminal, and an output terminal;
an interface unit configured for connecting to a host computer, receiving an out-of-band (OOB) signal from the host computer, and transmitting the OOB signal to the clock input terminal of the D flip-flop; and
a processing unit configured for transmitting a reset signal to the data input terminal of the D flip-flop and detecting a change of an output value from the output terminal of the D flip-flop;
wherein when the change is detected by the processing unit, the processing unit instructs the power supply to provide power to the storage unit.

2. The external storage device of claim 1, wherein the processing unit is configured for detecting the change when an output voltage of the output terminal of the D flip-flop changes from a low voltage level to a high voltage level or vice versa.

3. The external storage device of claim 2, further comprising a cooling fan, wherein when the processing unit detects the change, the processing unit is instructs the power supply to provide power to the cooling fan and instructs the cooling fan to rotate.

4. The external storage device of claim 3, further comprising a temperature sensor configured for measuring an internal temperature of the external storage device, wherein the processing unit is further configured for instructing the cooling fan to adjust a rotational speed according to the internal temperature measured by the temperature sensor.

5. The external storage device of claim 1, wherein when the clock input terminal receives the OOB signal and the data input terminal receives the reset signal simultaneously, the output terminal generates the change of the output value.

6. The external storage device of claim 1, wherein the output terminal do not generate the change of the output value when the OOB signal is not received by the clock input terminal or the reset signal is not received by the data input terminal, the output value on the output terminal maintains unchanged.

7. An external storage device, comprising:
a D flip-flop comprising a clock input terminal, a data input terminal, and an output terminal;
an interface unit configured for connecting to a host computer, receiving an out-of-band (OOB) signal from the host computer, and transmitting the OOB signal to the clock input terminal of the D flip-flop; and
a processing unit configured for transmitting a reset signal to the data input terminal and detecting a change of an output value from the output terminal of the D flip-flop;
wherein when the changes is detected by the processing unit, the processing unit is configured for executing a start-up operation of the external storage device.

8. The external storage device of claim 7, wherein the processing unit is configured for detecting the change when an output voltage of the output terminal of the D flip-flop changes from a low voltage level to a high voltage level or vice versa.

9. The external storage device of claim 8, further comprising a storage unit and a power supply, wherein when the changes is detected by the processing unit, the processing unit is configured for instructing the power supply to provide power to the storage unit.

10. The external storage device of claim 9, further comprising a cooling fan, wherein when the processing unit detects the change, the processing unit is instructs the power supply to provide power to the cooling fan and instructs the cooling fan to rotate.

11. The external storage device of claim 10, further comprising a temperature sensor configured for measuring an internal temperature of the external storage device, wherein the processing unit is further configured for instructing the cooling fan to adjust a rotational speed according to the internal temperature measured by the temperature sensor.

12. The external storage device of claim 7, wherein when the clock input terminal receives the OOB signal and the data input terminal receives the reset signal simultaneously, the output terminal generates the change of the output value.

13. The external storage device of claim 7, wherein the output terminal do not generate the change of the output value when the OOB signal is not received by the clock input terminal or the reset signal is not received by the data input terminal, the output value on the output terminal maintains unchanged.

14. A method for starting up an external storage device, comprising:
receiving an out-of-band (OOB) signal from a host computer by an interface unit;
transmitting the OOB signal to a clock input terminal of a D flip-flop by the interface unit;
transmitting a reset signal to a data input terminal of the D flip-flop by a processing unit;
detecting a change of an output value from the output terminal of the D flip-flop changes by the processing unit; and
executing, by the processing unit, a start-up operation of the external storage device when the change is detected by the processing unit.

15. The method of claim 14, further comprising:
detecting the change by the processing unit when an output voltage of the output terminal of the D flip-flop changes from a low voltage level to a high voltage level or vice versa.

16. The method of claim 15, further comprising:
instructing, by the processing unit, a power supply to provide power to a storage unit when the change is detected by the processing unit.

17. The method of claim 16, further comprising:
instructing, by the processing unit, the power supply to provide power to a cooling fan and instructing the cooling fan to rotate when the change is detected by the processing unit.

18. The method of claim 17, further comprising:
measuring, by a temperature sensor, an internal temperature of the external storage device; and
adjusting, by a processing unit, a rotation speed of the cooling fan according to the internal temperature measure by the temperature sensor.

19. The method of claim 14, wherein when the clock input terminal receives the OOB signal and the data input terminal receives the reset signal simultaneously, the processing unit detects the change.

20. The method of claim 14, wherein when the OOB signal is not received by the clock input terminal or the reset signal is not received by the data input terminal, the processing unit does not detect the change.
